(19) United States
(12) Patent Application Publication
(10) Pub. No.: US 2026/0019626 A1
(43) Pub. Date: Jan. 15, 2026

(54) Method and Apparatus for Inter Prediction using Template Matching in Video Coding Systems

(71) Applicant: MEDIATEK INC., Hsinchu City (TW)

(72) Inventors: Chih-Hsuan LO, Hsinchu City (TW); Tzu-Der CHUANG, Hsinchu City (TW); Ching-Yeh CHEN, Hsinchu City (TW); Chih-Wei HSU, Hsinchu City (TW)

(21) Appl. No.: 18/993,761

(22) PCT Filed: Jul. 10, 2023
(86) PCT No.: PCT/CN2023/106524

§ 371 Date: Jan. 13, 2025

Related U.S. Application Data
(60) Provisional application No. 63/368,382, filed on Jul. 14, 2022.
(60) Provisional application No. 63/368,778, filed on Jul. 19, 2022.
(60) Provisional application No. 63/478,704, filed on Jan. 6, 2023.

(51) Int. Cl. H04N 19/52; H04N 19/124

(52) U.S. Cl. CPC H04N 19/52; H04N 19/124

(57) ABSTRACT

A method and apparatus for inter direction determination according to template matching costs. An L0 matching cost between a first template corresponding a first neighbouring region of the first reference block and a current template corresponding to a current neighbouring region of the current block is determined. An L1 matching cost between a second template corresponding to a neighbouring region of the second reference block and the current template is determined. Inter direction of the MVP candidate for the current block is determined based on first information comprising the L0 matching cost and the L1 matching cost where the inter direction corresponds to bi-prediction, L0 uni-prediction or L1 uni-prediction. The MVP candidate is inserted into an AMVP (Adaptive MVP) list or a merge list. The current block is encoded or decoded by using second information comprising the MVP list or the merge list.

### CROSS REFERENCE TO RELATED APPLICATIONS

The present invention is a non-Provisional Application of and claims priority to U.S. Provisional Patent Application No. 63/368,382, filed on Jul. 14, 2022, U.S. Provisional Patent Application No. 63/368,778, filed on Jul. 19, 2022 and, U.S. Provisional Patent Application No. 63/478,704, filed on Jan. 6, 2023. The U.S. Provisional Patent Applications are hereby incorporated by reference in their entireties.

### FIELD OF THE INVENTION

The present invention relates to video coding system. In particular, the present invention relates to determining inter mode direction using the template matching cost in a video coding system.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264, VVC or any other video coding standard.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Among various new coding tools, some coding tools relevant to the present invention are reviewed as follows.

### Inter Prediction Overview

According to JVET-T2002 Section 3.4. (Jianle Chen, et. al., “Algorithm description for Versatile Video Coding and Test Model 11 (VTM 11)”, Joint Video Experts Team (JVET) of ITU-T SG 16 WP 3 and ISO/IEC JTC 1/SC 29, 20th Meeting, by teleconference, 7-16 Oct. 2020, Document: JVET-T2002)), for each inter-predicted CU, motion parameters consist of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU, which are obtained from neighbouring CUs, including spatial and temporal candidates, and additional schedules introduced in VVC. The merge mode can be applied to any inter-predicted CU, not only for skip mode. The alternative to the merge mode is the explicit transmission of motion parameters, where motion vector, corresponding reference picture index for each reference picture list and reference picture list usage flag and other needed information are signalled explicitly per each CU.

Beyond the inter coding features in HEVC, VVC includes a number of new and refined inter prediction coding tools listed as follows:
Extended merge prediction
Merge mode with MVD (MMVD)
Symmetric MVD (SMVD) signalling
Affine motion compensated prediction
Subblock-based temporal motion vector prediction (SbTMVP)
Adaptive motion vector resolution (AMVR)
Motion field storage: 1/16^{th} luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)

The following description provides the details of those inter prediction methods specified in VVC.

### Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

The size of merge list is signalled in sequence parameter set (SPS) header and the maximum allowed size of merge list is 6. For each CU coded in the merge mode, an index of best merge candidate is encoded using truncated unary binarization (TU). The first bin of the merge index is coded with context and bypass coding is used for remaining bins.

The derivation process of each category of the merge candidates is provided in this session. As done in HEVC, VVC also supports parallel derivation of the merge candidate lists (or called as merging candidate lists) for all CUs within a certain size of area.

The derivation of spatial merge candidates in VVC is the same as that in HEVC except that the positions of first two merge candidates are swapped. A maximum of four merge candidates (B₀. A₀. B₁ and A₁) for current CU 210 are selected among candidates located in the positions depicted in FIG. 2. The order of derivation is B₀. A₀. B₁. A₁ and B₂. Position B₂ is considered only when one or more neighbouring CU of positions B₀, A₀, B₁, A₁ are not available (e.g. belonging to another slice or tile) or is intra coded. After candidate at position A₁ is added, the addition of the remaining candidates is subject to a redundancy check which ensures that candidates with the same motion information are excluded from the list so that coding efficiency is improved.

Merge Mode with MVD (MMVD)

In addition to the merge mode, where the implicitly derived motion information is directly used for prediction samples generation of the current CU, the merge mode with motion vector differences (MMVD) is introduced in VVC. A MMVD flag is signalled right after sending a regular merge flag to specify whether MMVD mode is used for a CU.

In MMVD, after a merge candidate is selected (referred as a base merge candidate in this disclosure), it is further refined by the signalled MVDs information. The further information includes a merge candidate flag, an index to specify motion magnitude, and an index for indication of motion direction. In MMVD mode, one for the first two candidates in the merge list is selected to be used as MV basis. The MMVD candidate flag is signalled to specify which one is used between the first and second merge candidates.

Distance index specifies motion magnitude information and indicates the pre-defined offset from the starting points (312 and 322) for a L0 reference block 310 and L1 reference block 320. As shown in FIG. 3, an offset is added to either horizontal component or vertical component of the starting MV, where small circles in different styles correspond to different offsets from the centre. The relation of distance index and pre-defined offset is specified in Table 1.

TABLE 1
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent the four directions as shown in Table 1. It is noted that the meaning of MVD sign could be variant according to the information of starting MVs. When the starting MVs are an un-prediction MV or bi-prediction MVs with both lists pointing to the same side of the current picture (i.e. POCs of two references both larger than the POC of the current picture, or both smaller than the POC of the current picture), the sign in Table 2 specifies the sign of the MV offset added to the starting MV. When the starting MVs are bi-prediction MVs with the two MVs pointing to the different sides of the current picture (i.e. the POC of one reference larger than the POC of the current picture, and the POC of the other reference smaller than the POC of the current picture), and the difference of POC in list 0 is greater than the one in list 1, the sign in Table 2 specifies the sign of MV offset added to the list0 MV component of the starting MV and the sign for the list1 MV has an opposite value. Otherwise, if the difference of POC in list 1 is greater than list 0, the sign in Table 2 specifies the sign of the MV offset added to the list1 MV component of starting MV and the sign for the list0 MV has an opposite value.

The MVD is scaled according to the difference of POCs in each direction. If the differences of POCs in both lists are the same, no scaling is needed. Otherwise, if the difference of POC in list 0 is larger than the one in list 1, the MVD for list 1 is scaled, by defining the POC difference of L0 as td and POC difference of L1 as tb. If the POC difference of L1 is greater than L0, the MVD for list 0 is scaled in the same way. If the starting MV is uni-predicted, the MVD is added to the available MV.

TABLE 2
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### Geometric Partitioning Mode (GPM)

In VVC, a Geometric Partitioning Mode (GPM) is supported for inter prediction as described in JVET-W2002 (Adrian Browne, et al., Algorithm description for Versatile Video Coding and Test Model 14 (VTM 14), ITU-T/ISO/IEC Joint Video Exploration Team (JVET), 23rd Meeting, by teleconference, 7-16 Jul. 2021, document: document JVET-M2002). The geometric partitioning mode is signalled using a CU-level flag as one kind of merge mode, with other merge modes including the regular merge mode, the MMVD mode, the CIIP mode and the subblock merge mode. A total of 64 partitions are supported by geometric partitioning mode for each possible CU size, w×h=2^{m}×2ⁿ with m, n∈{3 . . . 6} excluding 8×64 and 64×8. The GPM mode can be applied to skip or merge CUs having a size within the above limit and having at least two regular merge modes.

When this mode is used, a CU is split into two parts by a geometrically located straight line in certain angles. In VVC, there are a total of 20 angles and 4 offset distances used for GPM, which has been reduced from 24 angles in an earlier draft. The location of the splitting line is mathematically derived from the angle and offset parameters of a specific partition. In VVC, there are a total of 64 partitions as shown in FIG. 4, where the partitions are grouped according to their angles and dashed lines indicate redundant partitions. Each part of a geometric partition in the CU is inter-predicted using its own motion; only uni-prediction is allowed for each partition, that is, each part has one motion vector and one reference index. In FIG. 4, each line corresponds to the boundary of one partition. The partitions are grouped according to its angle. For example, partition group 410 consists of three vertical GPM partitions (i.e.,90°). Partition group 420 consists of four slant GPM partitions with a small angle from the vertical direction. Also, partition group 430 consists of three vertical GPM partitions (i.e., 270°) similar to those of group 410, but with an opposite direction. The uni-prediction motion constraint is applied to ensure that only two motion compensated prediction are needed for each CU, same as the conventional bi-prediction. The uni-prediction motion for each partition is derived using the process described later.

If geometric partitioning mode is used for the current CU, then a geometric partition index indicating the selected partition mode of the geometric partition (angle and offset), and two merge indices (one for each partition) are further signalled. The number of maximum GPM candidate size is signalled explicitly in SPS (Sequence Parameter Set) and specifies syntax binarization for GPM merge indices. After predicting each of part of the geometric partition, the sample values along the geometric partition edge are adjusted using a blending processing with adaptive weights using the process described later. This is the prediction signal for the whole CU, and transform and quantization process will be applied to the whole CU as in other prediction modes. Finally, the motion field of a CU predicted using the geometric partition modes is stored using the process described later.

### Combined Inter and Intra Prediction (CIIP)

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value wt is calculated depending on the coding modes of the top and left neighbouring blocks (as shown in FIG. 5) of current CU 510 as follows:
If the top neighbour is available and intra coded, then set isIntraTop to 1, otherwise set isIntraTop to 0;
If the left neighbour is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - wt ) * {P}_{inter} + wt * {P}_{intra} + 2 ) ≫ 2 \qquad ( 1 )$$

### Adaptive Motion Vector Resolution (AMVR)

In HEVC, motion vector differences (MVDs) (between the motion vector and predicted motion vector of a CU) are signalled in units of quarter-luma-sample when use_integer_mv_flag is equal to 0 in the slice header. In VVC, a CU-level adaptive motion vector resolution (AMVR) scheme is introduced. AMVR allows MVD of the CU to be coded in different precisions. Dependent on the mode (normal AMVP mode or affine AVMP mode) for the current CU, the MVDs of the current CU can be adaptively selected as follows:
Normal AMVP mode: quarter-luma-sample, half-luma-sample, integer-luma-sample or four-luma-sample.
Affine AMVP mode: quarter-luma-sample, integer-luma-sample or 1/16 luma-sample.

The CU-level MVD resolution indication is conditionally signalled if the current CU has at least one non-zero MVD component. If all MVD components (that is, both horizontal and vertical MVDs for reference list L0 and reference list L1) are zero, quarter-luma-sample MVD resolution is inferred.

For a CU that has at least one non-zero MVD component, a first flag is signalled to indicate whether quarter-luma-sample MVD precision is used for the CU. If the first flag is 0, no further signalling is needed and quarter-luma-sample MVD precision is used for the current CU. Otherwise, a second flag is signalled to indicate half-luma-sample or other MVD precisions (integer or four-luma sample) is used for a normal AMVP CU. In the case of half-luma-sample, a 6-tap interpolation filter instead of the default 8-tap interpolation filter is used for the half-luma sample position. Otherwise, a third flag is signalled to indicate whether integer-luma-sample or four-luma-sample MVD precision is used for the normal AMVP CU. In the case of affine AMVP CU, the second flag is used to indicate whether integer-luma-sample or 1/16 luma-sample MVD precision is used. In order to ensure the reconstructed MV has the intended precision (quarter-luma-sample, half-luma-sample, integer-luma-sample or four-luma-sample), the motion vector predictors for the CU will be rounded to the same precision as that of the MVD before being added together with the MVD. The motion vector predictors are rounded toward zero (that is, a negative motion vector predictor is rounded toward positive infinity and a positive motion vector predictor is rounded toward negative infinity).

The encoder determines the motion vector resolution for the current CU using RD check. To avoid always performing the CU-level RD check four times for each MVD resolution, the RD check of MVD precisions other than quarter-luma-sample is only invoked conditionally in VTM11. For the normal AVMP mode, the RD cost of quarter-luma-sample MVD precision and integer-luma sample MV precision is computed first. Then, the RD cost of integer-luma-sample MVD precision is compared to that of quarter-luma-sample MVD precision to decide whether it is necessary to further check the RD cost of four-luma-sample MVD precision. When the RD cost for the quarter-luma-sample MVD precision is much smaller than that of the integer-luma-sample MVD precision, the RD check of four-luma-sample MVD precision is skipped. Then, the check of half-luma-sample MVD precision is skipped if the RD cost of integer-luma-sample MVD precision is significantly larger than the best RD cost of previously tested MVD precisions. For the affine AMVP mode, if the affine inter mode is not selected after checking rate-distortion costs of affine merge/skip mode, merge/skip mode, quarter-luma-sample MVD precision normal AMVP mode and quarter-luma-sample MVD precision affine AMVP mode, then 1/16 luma-sample MV precision and 1-pel MV precision affine inter modes are not checked. Furthermore, affine parameters obtained in quarter-luma-sample MV precision affine inter mode are used as starting search point in 1/16 luma-sample and quarter-luma-sample MV precision affine inter modes.

Bi-Prediction with CU-level Weight (BCW)

In HEVC, the bi-prediction signal, P_{bi-pred} is generated by averaging two prediction signals, P₀ and P₁ obtained from two different reference pictures and/or using two different motion vectors. In VVC, the bi-prediction mode is extended beyond simple averaging to allow weighted average of the two prediction signals.

$${P}_{bi - pred} = ( ( 8 - w ) * {P}_{0} + w * {P}_{1} + 4 ) ≫ 3 \qquad ( 2 )$$

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w∈{3,4,5}) are used. At the encoder, fast search algorithms are applied to find the weight index without significantly increasing the encoder complexity. These algorithms are summarized as follows. The details are disclosed in the VTM software and document JVET-L0646 (Yu-Chi Su, et. al., “CE4-related: Generalized bi-prediction improvements combined from JVET-L0197 and JVET-L0296”, Joint Video Experts Team (JVET) of ITU-T SG 16 WP 3 and ISO/IEC JTC 1/SC 29, 12th Meeting: Macao, CN, 3-12 Oct. 2018, Document: JVET-L0646).
When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP is also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and weight w is inferred to be 4 (i.e. equal weight is applied). For a merge CU, the weight index is inferred from neighbouring blocks based on the merge candidate index. This can be applied to both the normal merge mode and inherited affine merge mode. For the constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, (i.e., w=4 for equal weight). Equal weight implies the default value for the BCW index.

### Symmetric MVD (SMVD) Coding

In VVC, besides the normal unidirectional prediction and bi-directional prediction mode MVD signalling, symmetric MVD mode for bi-prediction MVD signalling is applied. In the symmetric MVD mode, motion information including reference picture indices of both list-0 and list-1 and MVD of list-1 are not signalled but derived.

The decoding process of the symmetric MVD mode is as follows:

1. At slice level, variables BiDirPredFlag, RefIdxSymL0 and RefIdxSymL1 are derived as follows:
If mvd_11_zero_flag is 1, BiDirPredFlag is set equal to 0.
Otherwise, if the nearest reference picture in list-0 and the nearest reference picture in list-1 form a forward and backward pair of reference pictures or a backward and forward pair of reference pictures, BiDirPredFlag is set to 1, and both list-0 and list-1 reference pictures are short-term reference pictures. Otherwise BiDirPredFlag is set to 0.

2. At CU level, a symmetrical mode flag indicating whether symmetrical mode is used or not is explicitly signaled if the CU is bi-prediction coded and BiDirPredFlag is equal to 1.

When the symmetrical mode flag is true, only mvp_10_flag, mvp_11_flag and MVD0 are explicitly signaled. The reference indices for list-0 and list-1 are set equal to the pair of reference pictures, respectively. MVD1 is set equal to (−MVD0). The final motion vectors are shown in below formula.

$$\{ \begin{matrix}( {mvx}_{0} , {mvy}_{0} = ( {mvpx}_{0} + {mvdx}_{0} , {mvpy}_{0} + {mvdy}_{0} ) \\ ( {mvx}_{1} , {mvy}_{1} = ( {mvpx}_{1} - {mvdx}_{0} , {mvpy}_{1} - {mvdy}_{0} )\end{matrix}$$

In the encoder, symmetric MVD motion estimation starts with initial MV evaluation. A set of initial MV candidates comprising of the MV obtained from uni-prediction search, the MV obtained from bi-prediction search and the MVs from the AMVP list. The one with the lowest rate-distortion cost is chosen to be the initial MV for the symmetric MVD motion search.

FIG. 6 illustrates an example of symmetric MVD mode, where frames 600, 610 and 620 correspond to the current picture, list-0 reference picture and list-1 reference picture respectively. Block 602 corresponds to the current block, blocks 614 and 622 correspond to the reference blocks according to the initial MV evaluation. The final MVs are determined by searching around the initial MVs and the lowest cost positions are selected as the final reference blocks (612 and 624). The MVDs are labels as 616 and 626.

### Affine Motion Compensated Prediction

In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction is applied. As shown FIG. 7A-B, the affine motion field of the block 710 is described by motion information of two control point (4-parameter) in FIG. 7A or three control point motion vectors (6-parameter) in FIG. 7B.

For 4-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{1 y} - {mv}_{0 y}}{W} y + {mv}_{0 x} \\ {mv}_{y} = \frac{{mv}_{1 y} - {mv}_{0 y}}{W} x + \frac{{mv}_{1 y} - {mv}_{0 x}}{W} y + {mv}_{0 y}\end{matrix} \qquad ( 3 )$$

For 6-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} \qquad ( 4 )$$

Where (mv₀ₓ, mv_{0y}) is motion vector of the top-left corner control point, (mv₁ₓ, mv_{1y}) is motion vector of the top-right corner control point, and (mv₂ₓ, mv₂ₓ) is motion vector of the bottom-left corner control point.

In order to simplify the motion compensation prediction, block based affine transform prediction is applied. To derive motion vector of each 4×4 luma subblock, the motion vector of the centre sample of each subblock, as shown in FIG. 8, is calculated according to above equations, and rounded to 1/16 fraction accuracy. Then, the motion compensation interpolation filters are applied to generate the prediction of each subblock with the derived motion vector. The subblock size of chroma-components is also set to be 4×4. The MV of a 4×4 chroma subblock is calculated as the average of the MVs of the top-left and bottom-right luma subblocks in the collocated 8×8 luma region.

As is for translational-motion inter prediction, there are also two affine motion inter prediction modes: affine merge mode and affine AMVP mode.

### Affine Merge Prediction

AF_MERGE mode can be applied for CUs with both width and height larger than or equal to 8. In this mode, the CPMVs (Control Point MVs) of the current CU is generated based on the motion information of the spatial neighbouring CUs. There can be up to five CPMVP (CPMV Prediction) candidates and an index is signalled to indicate the one to be used for the current CU. The following three types of CPVM candidate are used to form the affine merge candidate list:
Inherited affine merge candidates that are extrapolated from the CPMVs of the neighbour CUs
Constructed affine merge candidates CPMVPs that are derived using the translational MVs of the neighbour CUs
Zero MVs

In VVC, there are two inherited affine candidates at most, which are derived from the affine motion model of the neighbouring blocks, one from left neighbouring CUs and one from above neighbouring CUs. The candidate blocks are the same as those shown in FIG. 2. For the left predictor, the scan order is A₀->A₁, and for the above predictor, the scan order is B₀->B₁->B₂. Only the first inherited candidate from each side is selected. No pruning check is performed between two inherited candidates. When a neighbouring affine CU is identified, its control point motion vectors are used to derived the CPMVP candidate in the affine merge list of the current CU. As shown in FIG. 9, if the neighbouring left bottom block A of the current block 910 is coded in affine mode, the motion vectors v₂, v₃ and v₄ of the top left corner, above right corner and left bottom corner of the CU 920 containing block A are attained. When block A is coded with 4-parameter affine model, the two CPMVs of the current CU (i.e., v₀ and v₁) are calculated according to v₂, and v₃. In case that block A is coded with 6-parameter affine model, the three CPMVs of the current CU are calculated according to v₂, v₃ and v₄.

Constructed affine candidate means the candidate is constructed by combining the neighbouring translational motion information of each control point. The motion information for the control points is derived from the specified spatial neighbours and temporal neighbour for a current block 910 as shown in FIG. 9. CPMVₖ (k=1, 2, 3, 4) represents the k-th control point. For CPMV₁, the B₂->B₃->A₂ blocks are checked and the MV of the first available block is used. For CPMV₂, the B1->B0 blocks are checked and for CPMV₃, the A₁->A₀ blocks are checked. For TMVP is used as CPMV₄ if it's available.

After MVs of four control points are attained, affine merge candidates are constructed based on the motion information. The following combinations of control point MVs are used to construct in order:
{CPMV₁, CPMV₂, CPMV₃}, {CPMV₁, CPMV₂, CPMV₄}, {CPMV₁, CPMV₃, CPMV₄}, {CPMV₂, CPMV₃, CPMV₄}, {CPMV₁, CPMV₂}, {CPMV₁, CPMV₃}

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

After inherited affine merge candidates and constructed affine merge candidate are checked, if the list is still not full, zero MVs are inserted to the end of the list.

Affine AMVP Prediction Affine AMVP mode can be applied for CUs with both width and height larger than or equal to 16. An affine flag in the CU level is signalled in the bitstream to indicate whether affine AMVP mode is used and then another flag is signalled to indicate whether 4-parameter affine or 6-parameter affine is used. In this mode, the difference of the CPMVs of current CU and their predictors CPMVPs is signalled in the bitstream. The affine AVMP candidate list size is 2 and it is generated by using the following four types of CPVM candidate in order:
Inherited affine AMVP candidates that extrapolated from the CPMVs of the neighbour CUs
Constructed affine AMVP candidates CPMVPs that are derived using the translational MVs of the neighbour CUs
Translational MVs from neighbouring CUs
Zero MVs

The checking order of inherited affine AMVP candidates is the same as the checking order of inherited affine merge candidates. The only difference is that, for AVMP candidate, only the affine CU that has the same reference picture as current block is considered. No pruning process is applied when inserting an inherited affine motion predictor into the candidate list.

Constructed AMVP candidate is derived from the specified spatial neighbours of current block 1010 shown in FIG. 10. The same checking order is used as that in the affine merge candidate construction. In addition, the reference picture index of the neighbouring block is also checked. In the checking order, the first block that is inter coded and has the same reference picture as in current CUs is used. When the current CU is coded with the 4-parameter affine mode, and mv₀ and mv₁ are both available, they are added as one candidate in the affine AMVP list. When the current CU is coded with 6-parameter affine mode, and all three CPMVs are available, they are added as one candidate in the affine AMVP list. Otherwise, the constructed AMVP candidate is set as unavailable.

If the number of affine AMVP list candidates is still less than 2 after valid inherited affine AMVP candidates and constructed AMVP candidate are inserted, mv₀, mv₁ and mv₂ will be added as the translational MVs in order to predict all control point MVs of the current CU, when available. Finally, zero MVs are used to fill the affine AMVP list if it is still not full.

### Subblock-based Temporal Motion Vector Prediction (SbTMVP) in VVC

VVC supports the subblock-based temporal motion vector prediction (SbTMVP) method. Similar to the temporal motion vector prediction (TMVP) in HEVC, SbTMVP uses the motion field in the collocated picture to improve motion vector prediction and merge mode for CUs in the current picture. The same collocated picture used by TMVP is used for SbTMVP. SbTMVP differs from TMVP in the following two main aspects:
TMVP predicts motion at CU level but SbTMVP predicts motion at sub-CU level:
Whereas TMVP fetches the temporal motion vectors from the collocated block in the collocated picture (the collocated block is the bottom-right or center block relative to the current CU). SbTMVP applies a motion shift before fetching the temporal motion information from the collocated picture, where the motion shift is obtained from the motion vector from one of the spatial neighboring blocks of the current CU.

The SbTMVP process is illustrated in FIGS. 11A-B. SbTMVP predicts the motion vectors of the sub-CUs within the current CU in two steps. In the first step, the spatial neighbour A1 in FIG. 11A is examined. If A1 has a motion vector that uses the collocated picture as its reference picture, this motion vector is selected to be the motion shift to be applied. If no such motion is identified, then the motion shift is set to (0, 0).

In the second step, the motion shift identified in Step 1 is applied (i.e. added to the current block's coordinates) to obtain sub-CU level motion information (motion vectors and reference indices) from the collocated picture as shown in FIG. 11B. The example in FIG. 11B assumes the motion shift is set to block A1's motion, where frame 1120 corresponds to the current picture and frame 1130 corresponds to a reference picture (i.e., a collocated picture). Then, for each sub-CU, the motion information of its corresponding block (the smallest motion grid that covers the center sample) in the collocated picture is used to derive the motion information for the sub-CU. After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU. In FIG. 11B, the arrow(s) in each subblock of the collocated picture 1130 correspond(s) to the motion vector(s) of a collocated subblock (thick-lined arrow for L0 MV and thin-lined arrow for L1 MV). For the current picture 1120, the arrow(s) in each subblock correspond(s) to the scaled motion vector(s) of a current subblock (thick-lined arrow for L0 MV and thin-lined arrow for L1 MV).

In VVC, a combined subblock based merge list, which contains both SbTMVP candidate and affine merge candidates, is used for the signalling of subblock based merge mode. The SbTMVP mode is enabled/disabled by a sequence parameter set (SPS) flag. If the SbTMVP mode is enabled, the SbTMVP predictor is added as the first entry of the list of subblock based merge candidates, and followed by the affine merge candidates. The size of subblock based merge list is signalled in SPS and the maximum allowed size of the subblock based merge list is 5 in VVC.

The sub-CU size used in SbTMVP is fixed to be 8×8, and as done for the affine merge mode, SbTMVP mode is only applicable to the CU with both width and height are larger than or equal to 8.

The encoding processing flow of the additional SbTMVP merge candidate is the same as for the other merge candidates, that is, for each CU in P or B slice, an additional RD check is performed to decide whether to use the SbTMVP candidate.

Bi-directional optical flow (BDOF)

The bi-directional optical flow (BDOF) tool is included in VVC. BDOF, previously referred to as BIO, was included in the JEM. Compared to the JEM version, the BDOF in VVC is a simpler version that requires much less computations, especially in terms of number of multiplications and the size of the multiplier.

BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order.
The distances (i.e. POC difference) from two reference pictures to the current picture are same.
Both reference pictures are short-term reference pictures.
The CU is not coded using affine mode or the SbTMVP merge mode.
CU has more than 64 luma samples.
Both CU height and CU width are larger than or equal to 8 luma samples
BCW weight index indicates equal weight.
WP is not enabled for the current CU.
CIIP mode is not used for the current CU.

BDOF is only applied to the luma component. As its name indicates, the BDOF mode is based on the optical flow concept, which assumes that the motion of an object is smooth. For each 4×4 subblock, a motion refinement (Vx, Vy) is calculated by minimizing the difference between the L0 and L1 prediction samples. The motion refinement is then used to adjust the bi-predicted sample values in the 4×4 subblock.

### Decoder Side Motion Vector Refinement (DMVR) in VVC

In order to increase the accuracy of the MVs of the merge mode, a bilateral-matching (BM) based decoder side motion vector refinement is applied in VVC. In bi-prediction operation, a refined MV is searched around the initial MVs (1232 and 1234) in the list L0 reference picture 1212 and list L1 reference picture 1214 for a current block 1220 of the current picture 1210. The collocated blocks 1222 and 1224 in L0 and L1 are determined according to the initial MVs 1232 and 1234) and the location of the current block 1220 in the current picture as shown in FIG. 12. The BM method calculates the distortion between the two candidate blocks (1242 and 1244) in the reference picture list L0 and list L1. The locations of the two candidate blocks (1242 and 1244) are determined by adding two opposite offset (1262 and 1264) to the two initial MVs (1232 and 1234) to derive the two candidate MVs (1252 and 1254). As illustrated in FIG. 12, the SAD between the candidate blocks (1242 and 1244) based on each MV candidate around the initial MV (1232 or 1234) is calculated. The MV candidate (1252 or 1254) with the lowest SAD becomes the refined MV and is used to generate the bi-predicted signal.

In VVC, the application of DMVR is restricted and is only applied for the CUs which are coded with following modes and features:
CU level merge mode with bi-prediction MV
One reference picture is in the past and another reference picture is in the future with respect to the current picture
The distances (i.e. POC difference) from two reference pictures to the current picture are same
Both reference pictures are short-term reference pictures
CU has more than 64 luma samples
Both CU height and CU width are larger than or equal to 8 luma samples
BCW weight index indicates equal weight
WP is not enabled for the current block
CIIP mode is not used for the current block

The refined MV derived by the DMVR process is used to generate the inter prediction samples and also used in temporal motion vector prediction for future pictures coding. While the original MV is used in the deblocking process and also used in spatial motion vector prediction for future CU coding.

### Boundary Matching for Sign Prediction

Joint Video Expert Team (JVET) of ITU-T SG16 WP3 and ISO/IEC JTC1/SC29/WG11 are currently in the process of exploring the next-generation video coding standard. Some promising new coding tools have been adopted into Enhanced Compression Model 2 (ECM 2) (M. Coban, et al., “Algorithm description of Enhanced Compression Model 2 (ECM 2),” Joint Video Expert Team (JVET) of ITU-T SG 16 WP 3 and ISO/IEC JTC 1/SC 29, 23rd Meeting, by teleconference, 7-16 Jul. 2021, Doc. JVET-W2025) to further improve VVC. The adopted new tools have been implemented in the reference software ECM-2.0 (ECM reference software ECM-2.0, available at https://vcgit.hhi.fraunhofer.de/ecm/ECM [Online]). Particularly, a new method for jointly predicting a collection of signs of transform coefficient levels in a residual transform block has been developed (JVET-D0031, Felix Henry, et al., “Residual Coefficient Sign Prediction”, Joint Video Expert Team (JVET) of ITU-T SG 16 WP 3 and ISO/IEC JTC 1/SC 29, 4th Meeting: Chengdu, CN, 15-21 Oct. 2016, Doc. JVET-D0031). In ECM 2, to derive a best sign prediction hypothesis for a residual transform block, a cost function is defined as discontinuity measure across block boundaries shown on FIG. 13, where block 1310 corresponds to a transform block, circles 1320 correspond to neighbouring samples and circles 1330 correspond to reconstructed samples associated with sign candidates of block 1310. The cost function is defined as a sum of absolute second derivatives in the residual domain for the above row and left column as follows:

$$cost = {\sum }_{x = 0}^{w - 1} \vert ( - {R}_{x , - 2} + 2 {R}_{x , - 1} - {P}_{x , 0} ) - {r}_{x , 0} \vert + {\sum }_{y = 0}^{h - 1} \vert ( - {R}_{- 2 , y} + 2 {R}_{- 1 , y} - {P}_{0 , y} ) - {r}_{0 , y} \vert \qquad ( 5 )$$

In the above equation, R is reconstructed neighbours, P is prediction of the current block, and r is the residual hypothesis. The term (−R₋₁+2R₀-P₁) can be calculated only once per block and only residual hypothesis is subtracted.

The transform coefficients with the largest K qIdx value of the top-left 4×4 area are selected. qIdx value is the transform coefficient level after compensating the impact from the multiple quantizers in DQ. A larger qIdx value will produce a larger de-quantized transform coefficient level. qIdx is derived as follows

$$qIdx = ( abs ( level ) << 1 ) - ( state \& 1 ) ;$$

where level is the transform coefficient level parsed from the bitstream and state is a variable maintained by the encoder and decoder in DQ.

The sign prediction area was extended to maximum 32×32. Signs of top-left M×N block are predicted. The value of M and N is computed as follows:

$$\begin{matrix}M = min ( w , max W ) , \\ N = min ( h , max H ) ,\end{matrix}$$

where, w and h are the width and height of the transform block. The maximum area for sign prediction is not always set to 32×32. Encoder sets the maximum area (maxW, maxH) based on configuration, sequence class and QP, and signaled the area in SPS.

The maximum number of predicted signs is kept unchanged. The sign prediction is also applied to LFNST blocks. And for LFNST block, a maximum of 4 coefficients in the top-left 4×4 area are allowed to be sign predicted.

### Template Matching for MV Refinement

Template matching (TM) is a decoder-side MV derivation method to refine the motion information of the current CU by finding the closest match between a template (i.e., top 1414 and/or left 1416 neighbouring blocks of the current CU 1412) in the current picture 1410 and a block (i.e., same size to the template, block 1424 and 1426) in a reference picture 1420 as shown in FIG. 14. In FIG. 14, a better MV is searched around the initial motion 1430 of the current CU 1412 of the current picture 1410 within a [−8, +8]-pel search range 1422 around location 1428 in the reference picture 1420 as pointed by the initial MV 1430. The template matching method in JVET-J0021 is used with the following modifications: search step size is determined based on AMVR mode and TM can be cascaded with bilateral matching process in merge modes.

In the AMVP mode, an MVP candidate is determined based on the template matching error to select the one which reaches the minimum difference between the current block template and the reference block template. TM is then performed only for this particular MVP candidate for MV refinement. TM refines this MVP candidate by using iterative diamond search starting from full-pel MVD precision (or 4-pel for 4-pel AMVR mode) within a [−8, +8]-pel search range. The AMVP candidate may be further refined by using cross search with full-pel MVD precision (or 4-pel for 4-pel AMVR mode), followed sequentially by half-pel and quarter-pel ones depending on AMVR mode as specified in Table 3. This search process ensures that the MVP candidate still keeps the same MV precision as indicated by the AMVR mode after the TM process. In the search process, if the difference between the previous minimum cost and the current minimum cost in the iteration is less than a threshold that is equal to the area of the block, the search process terminates.

TABLE 3
Search patterns of AMVR and merge mode with AMVR.

| | AMVR mode | | | | Merge mode | |
|---|---|---|---|---|---|---|
| | | | | Quarter- | AltIF = | AltIF = |
| Search pattern | 4-pel | Full-pel | Half-pel | pel | 0 | 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| ⅛-pel cross | | | | | v | |

In the merge mode, similar search method is applied to the merge candidate indicated by the merge index. As shown in Table 3, TM may be performed all the way down to 1/8-pel MVD precision or skipping those beyond half-pel MVD precision, depending on whether the alternative interpolation filter (used for AMVR being a half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

### MVD Sign Prediction

In JVET-X0132 (Yan Zhang, et. al., “Non-EE2: On MVD sign prediction”, Joint Video Experts Team (JVET) of ITU-T SG 16 WP 3 and ISO/IEC JTC 1/SC 29, 24th Meeting, by teleconference, 6-15 Oct. 2021, Document: JVET-X0132), motion vector difference sign prediction can be applied in regular inter mode if the motion vector difference contains a non-zero component. Possible MVD sign combinations are sorted according to template matching cost and index corresponding to the true MVD sign is derived and coded with context model. At decoder side, the MVD signs are derived as following:
1. Parse the magnitude of MVD components,
2. Parse context-coded MVD sign prediction index,
3. Build MV candidates by creating combination between possible signs and absolute MVD value and add it to the MV predictor,
4. Derive MVD sign prediction cost for each derived MV based on template matching cost and sort,
5. Use MVD sign prediction index to pick the true MVD sign, and
6. Add the true MVD to the MV predictor for final MV.

Bilinear filter is used in reference template generation. The template matching cost is measured by the SAD between the neighbouring samples of the current CU and their corresponding reference samples, as illustrated in FIG. 15. In FIG. 15, The templates (1514 and 1516) for current PU 1512 in current picture 1510 are shown. Motion vector 1530 for PU 1512 points to a location P in reference picture 1520. Four MVD candidates based on absolute values of MVD (assuming both X and Y components of MVD being non-zero) are generated for four possible sign combinations. The locations of the four reference blocks associated with the four MVD candidates are labelled as A, B, C and D. For each MVD candidate, the template matching cost is measured. For example, for MVD candidate A, the matching cost between the templates (i.e., 1514 and 1516) of the current block (i.e., PU 1512) and the corresponding templates (i.e., 1524 and 1526) of MVD candidate A is calculated. The matching costs are calculated for all four MVD candidates and the one with the lowest cost is selected as the final MVD. Accordingly, the sign associated with the final MVD candidate is determined implicitly. The samples in the templates are already reconstructed for the current PU so that the decoder can perform the same process as the encoder.

Several other coding tools such as inter SMVD (Symmetric Motion Vector Difference) mode, affine mode, MMVD mode has been introduced during VVC standardization. In ECM, affine MMVD mode is additionally introduced. All these tools are either explicitly signalling the MVD signs that are part of MVD or implicitly signalling MVD signs through direction index. This indicates that MVSD can also be applied to these coding tools. When MVD sign prediction is applied to affine and affine MMVD mode, sub-block based template is used and the template matching cost for each sub-block are accumulated for the final cost. The template matching cost derivation for affine and affine MMVD modes are depicted in FIGS. 16A-B. As shown in FIG. 16A, the current block template (i.e., A₀, A₁, . . . , and L₀, L₁, . . . in FIG. 16A) is the same as that in the regular TM applied to translational motion model, but the reference block template (i.e., A₀, A₁, . . . , and L₀, L₁, . . . in FIG. 16B comprises multiple 4×4 sub-blocks pointed respectively to by the CPMV-derived MVs of the neighbouring sub-blocks at the CU boundary. The search process of Affine TM starts from the CPMV0, while keeping the other CPMV(s) constant, and the search is performed toward horizontal and vertical directions, followed by diagonal ones only if zero vector is not the best difference vector found from the horizontal/vertical search. Then, Affine TM repeats the same search process for CPMV1, and CPMV2, if 6-parameter model is used. Based on the refined CPMVs, the whole search process restarts from CPMV0, if zero vector is not the best difference vector from the previous iteration and the search process has iterated less than 3 times.

In case of bi-prediction in SMVD, MMVD and affine MMVD mode, to reduce complexity, only the template from reference list 0 is used to derive the template matching cost. When coding the MVD sign prediction index, different contexts are used depending on the magnitude of the MVD component. A pre-defined threshold is used to compare with the MVD component magnitude. Different threshold is used for translational inter mode and affine mode.

### Adaptive Reference Picture Reordering

In JVET-Y0139 (Han Huang, et. al., “Non-EE2: On the extended number of active reference pictures and reference picture reordering”, Joint Video Experts Team (JVET) of ITU-T SG 16 WP 3 and ISO/IEC JTC 1/SC 29, 25th Meeting, by teleconference, 12-21 Jan. 2022, Document: JVET-Y0139), the proposed reference picture reordering method is based on the template matching cost. For the uni-prediction AMVP mode, the reference pictures in List 0 and List 1 are interweaved to generate a joint list. For each hypothesis of the reference picture in the joint list, motion information can be derived accordingly and template matching is performed to calculate the cost. The joint list is reordered based on ascending order of the template matching cost. The index of the selected reference picture in the reordered joint list is signalled in the bitstream. For the bi-prediction AMVP mode, a list of pairs of reference pictures from List 0 and List 1 is generated and similarly reordered based on the template matching cost. The index of the selected pair is signalled in the bitstream.

### BRIEF SUMMARY OF THE INVENTION

A method and apparatus for inter prediction in video coding system are disclosed. According to the method, input data associated with a current block are received, wherein the input data comprise pixel data for the current block to be encoded at an encoder side or coded data associated with the current block to be decoded at a decoder side, and wherein an MVP (Motion Vector Prediction) candidate for the current block comprises a first MV predictor pointing to a first reference block in an L0 reference picture and a second MV predictor pointing to a second reference block in an L1 reference picture. An L0 matching cost between a first template corresponding to one or more first neighbouring regions of the first reference block and a current template corresponding to one or more current neighbouring regions of the current block is determined. An L1 matching cost between a second template corresponding to one or more second neighbouring regions of the second reference block and the current template is determined. Inter direction of the MVP candidate for the current block is determined based on first information comprising the L0 matching cost and the L1 matching cost, wherein the inter direction corresponds to bi-prediction, L0 uni-prediction or L1 uni-prediction. The MVP candidate is inserted into an AMVP (Adaptive MVP) list or a merge list. The current block is encoded or decoded by using second information comprising the MVP list or the merge list.

In one embodiment, a bi-prediction matching cost is calculated between a blended template and the current template, and wherein the blended template is derived by blending the first template and the second template. In one embodiment, the bi-prediction matching cost, the L0 matching cost and the L1 matching cost are calculated according to a sum of absolute differences (SAD) or a sum of squared differences (SSD).

In one embodiment, the bi-prediction matching cost is weighted by a factor smaller than 1 for matching cost comparison among the L0 matching cost, the L1 matching cost and the bi-prediction matching cost.

In one embodiment, the inter direction of the MVP candidate is determined for the current block on a per sample basis. In one embodiment, a target sample in the current block is a candidate to be changed from the bi-prediction to a uni-prediction if a difference between a corresponding L0 reference sample of the target sample and a corresponding L1 reference sample of the target sample is greater than a threshold.

In one embodiment, the target sample is changed to the L0 uni-prediction if the L0 matching cost is a smallest one among the L0 matching cost, the L1 matching cost and the bi-prediction matching cost, or changed to the L1 uni-prediction if the L1 matching cost is the smallest one among the L0 matching cost, the L1 matching cost and the bi-prediction matching cost. In one embodiment, the target sample stays to use the bi-prediction if the bi-prediction matching cost is the smallest one among the L0 matching cost, the L1 matching cost and the bi-prediction matching cost.

In one embodiment, the threshold is fixed or determined from a set of candidate thresholds. In another embodiment, the threshold is adaptively determined for the current block. In one embodiment, the threshold is adaptively selected from a set of candidate thresholds based on the L0 matching cost, the L1 matching cost and the bi-prediction matching cost calculated for each of the set of candidate thresholds, and the threshold corresponds to a target candidate threshold achieving a lowest matching cost among the set of candidate thresholds. In one embodiment, the threshold is adaptively selected from a set of candidate thresholds based on an incremental number associated with each of the set of candidate thresholds and the incremental number is calculated as an increase from a current total number of samples with absolute difference between L0 predictor and L1 predictor smaller than a current candidate threshold to a next total number of samples with the absolute difference between L0 predictor and L1 predictor smaller than a next candidate threshold, and the threshold corresponds to a target candidate threshold having a largest incremental number among the set of candidate thresholds. In one embodiment, the incremental number associated with each of the set of candidate thresholds is calculated for the current template, the first template and the second template individually to determine three corresponding thresholds for the current template, the first template and the second template, and if the three corresponding thresholds are the same, said determining the inter direction of the MVP candidate for the current block based on first information comprising the L0 matching cost and the L1 matching cost is applied; and if the three corresponding thresholds are not the same, said determining the inter direction of the MVP candidate for the current block based on first information comprising the L0 matching cost and the L1 matching cost is not applied.

In one embodiment, the threshold is dependent on QP (Quantization Parameter) of the current block, block size of the current block, one or more template matching costs of the current block, numbers of samples in the current block having differences between corresponding L0 and L1 reference samples falling in respective threshold intervals, or a combination thereof. In one embodiment, the threshold is set to a smaller value for a smaller QP (Quantization Parameter) of the current block.

In one embodiment, the current block is processed by BDOF (Bi-Directional Optical Flow) or MP-DMVR (Multi-Pass Decoder Side Motion Vector Refinement). In one embodiment, the MVP candidate for the current block corresponds to an inter AMVP candidate, an inter merge candidate, an Affine AMVP candidate, an Affine merge candidate, or an SbTMvp (Subblock-based Temporal Motion vector prediction) candidate.

In one embodiment, the current block corresponds to a luma block or a chroma block. In one embodiment, the threshold is different between the luma block and the chroma block.

In one embodiment, RD (Rate-Distortion) costs for the current block using per-sample-based inter direction determination and without using the per-sample-based inter direction determination are calculated to decide whether to apply the per-sample-based inter direction determination for the current block.

In one embodiment, three RD costs are calculated and a decision regarding whether to use the per-sample-based inter direction determination and a corresponding inter direction associated with a smallest RD cost are selected for the current block, and wherein a first RD cost corresponds to coding the current block using the bi-prediction, a second RD cost and a third RD cost correspond to coding the current block using the L0 uni-prediction and the L1 uni-prediction respectively for samples in the current block having differences between corresponding L0 and L1 reference samples greater than the threshold. In one embodiment, two bits are signalled to indicate whether to use the per-sample-based inter direction determination and the corresponding inter direction.

In one embodiment, two RD costs are calculated and a decision regarding whether to use the per-sample-based inter direction determination is determined for the current block, and wherein a first RD cost corresponds to coding the current block using the bi-prediction and a second RD cost corresponds to coding the current block using the L0 uni-prediction or the L1 uni-prediction according to the L0 matching cost and the L1 matching cost for samples in the current block having differences between corresponding L0 and L1 reference samples greater than the threshold. In one embodiment, one bit is signalled to indicate whether to use the per-sample-based inter direction determination.

In one embodiment, the inter direction of the MVP candidate is determined for the current block on a per block basis. In one embodiment, the MVP candidate corresponds to regular merge candidate, a GPM (Geometric Partitioning Mode) candidate, an MMVD (Merge Motion Vector Difference) candidate, a BM (Bilateral-Matching) candidate, or an Affine candidate, a CIIP candidate.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 illustrates the neighbouring blocks used for deriving spatial merge candidates for VVC.

FIG. 3 illustrates the distance offsets from a starting MV in the horizontal and vertical directions according to Merge Mode with MVD (MMVD).

FIG. 4 illustrates an example of the of 64 partitions used in the VVC standard, where the partitions are grouped according to their angles and dashed lines indicate redundant partitions.

FIG. 5 illustrates an example of the weight value derivation for Combined Inter and Intra Prediction (CIIP) according to the coding modes of the top and left neighbouring blocks.

FIG. 6 illustrates an example of symmetrical MVD mode.

FIG. 7A illustrates an example of the affine motion field of a block described by motion information of two control point (4-parameter).

FIG. 7B illustrates an example of the affine motion field of a block described by motion information of three control point motion vectors (6-parameter).

FIG. 8 illustrates an example of block based affine transform prediction, where the motion vector of each 4×4 luma subblock is derived from the control-point MVs.

FIG. 9 illustrates an example of derivation for inherited affine candidates based on control-point MVs of a neighbouring block.

FIG. 10 illustrates an example of affine candidate construction by combining the translational motion information of each control point from spatial neighbours and temporal neighbours.

FIG. 11A illustrates an example of subblock-based Temporal Motion Vector Prediction (SbTMVP) in VVC, where the spatial neighbouring blocks are checked for availability of motion information.

FIG. 11B illustrates an example of SbTMVP for deriving sub-CU motion field by applying a motion shift from a spatial neighbour and scaling the motion information from the corresponding collocated sub-CUs.

FIG. 12 illustrate an example of decoding side motion vector refinement.

FIG. 13 illustrates the cost function calculation to derive a best sign prediction hypothesis for a residual transform block according to Enhanced Compression Model 2 (ECM 2).

FIG. 14 illustrates an example of template matching used to refine an initial MV by searching an area around the initial MV.

FIG. 15 illustrates an example of template matching cost derivation used for MVD (motion vector difference) sign prediction.

FIG. 16A illustrates an example of template for the current block in affine template matching cost derivation.

FIG. 16B illustrates an example of template for the reference sub-block in affine template matching cost derivation.

FIG. 17 illustrates a flowchart of an exemplary video coding system that determines the inter direction for an MVP candidate according to template matching costs according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In the following, various inter prediction improvements according to the present invention are disclosed. In the present invention, sample-based inter mode determination methods using the template match cost are disclosed. The sample-based inter mode determination can adaptively change from the bi-prediction mode to a uni-prediction mode on a per sample basis.

### Implicit Sample-Based Inter Direction Determination

In the current ECM (Enhanced Compression Model) being developed for the next generation video coding technology, the inter direction of a CU can be determined by RD (Rate-Distortion) cost at the encoder side and the MVDs and reference indices of L0 and L1 can be signalled for inter AMVP modes (i.e., SMVD, AMVR, etc.) or the inter direction can be determined by the inherited CUs for inter merge modes. However, both ways are CU-based. That is, the whole CU should follow the same inter direction which loses the flexibility. According to the present invention, in some cases (e.g. object occlusion), the samples in foreground region might reference the samples in one of the predictors by uni-prediction and the bi-prediction blending is only applied to the samples in background region. Therefore, a sample-based inter direction determination method is proposed in this disclosure which can determine the inter direction of each sample independently with some criteria to improve the coding gain. The inter direction refers to the inter prediction mode as a uni-directional (using L0 or L1) or bi-directional (i.e., both L0 and L1) inter prediction.

In one embodiment, for a bi-prediction CU, a sample in the current CU will be changed to uni-prediction if the difference between the corresponding L0 and L1 reference samples is larger than a threshold. The threshold can be a fixed factor or determined by any adaptive method. To determine whether changing a sample to L0 or L1 uni-prediction, or keep using bi-prediction (i.e., staying with the bi-prediction), the template matching costs of bi-prediction template (the result of bi-prediction blending of L0 and L1 templates), L0 uni-prediction template and L1 uni-prediction template are calculated. The template with the minimum cost will be the best template and the corresponding inter direction will be the best inter direction. For the samples with the differences between the corresponding L0 and L1 reference samples larger than a threshold, the bi-prediction blending is replaced by uni-prediction following the best inter direction. if the L0 uni-prediction template or the L1 uni-prediction template has smallest cost. For the samples with the differences between the corresponding L0 and L1 reference samples larger than a threshold, if the bi-prediction matching cost is the smallest one among all matching costs, the samples stay with bi-prediction.

In one embodiment, a sample in a bi-prediction CU will be changed to uni-prediction if the difference between the corresponding L0 and L1 reference samples is larger than a threshold (denoted as Tf) selected from a threshold set (denoted as {T0, T1, . . . }). The threshold Tf is determined by the CU size, QP value, mean of the differences between L0 and L1 predictors or the numbers of samples that the differences between L0 and L1 predictors fall in a threshold interval (e.g. the number of samples with difference falling in [Ta, Tb)). The threshold Tf can be larger for larger QP value and can be the threshold Ta with most samples falling in the threshold interval. Any other information can be considered to determine the threshold. The threshold can be determined by using the coded information, for example, determined by the reconstructed neighbouring samples and the reference templates of L0 and/or L1 predictors. The threshold can also be signalled in the bitstream in TB/TU/CB/CU/CTU/CTU groups/CTU row/slice/picture/sequence-level.

In one embodiment, the template matching costs of bi-prediction template (the result of bi-prediction blending of L0 and L1 templates), L0 template and L1 template can be calculated by the sum of absolute differences (SAD) or the sum of squared differences (SSD), or the sum of absolute transformed differences (SATD). And the region to accumulate the sum of differences are determined by a threshold Tt (i.e., only the sample with the difference between corresponding L0 and L1 template samples larger than Tt will be used to calculate the template matching cost) which can be a fixed factor or the same as Tf or determined according to the numbers of samples that the differences between L0 and L1 templates fall in each threshold interval.

As mentioned above, the threshold can be determined by any adaptive method. For example, the threshold can be adaptively selected from a set of candidate thresholds such as 8 pre-defined threshold values, {32, 64, 96, 128, . . . , 256}. The TM costs associated with L0, L1 and Bi-prediction can be calculated for each candidate threshold. The inter direction for a target candidate threshold that causes the smallest TM cost is selected as the target threshold. Another example of adaptive threshold determination comprises counting the total number of absolute difference between corresponding L0 and L1 samples in the template being smaller than a selected candidate threshold. The incremental number from the current total number for a current candidate threshold to a next total number for a next candidate threshold is determined. The threshold for the current CU is selected from the candidate threshold that has the largest incremental number. In another example, the incremental number associated with each of the set of candidate thresholds is first calculated for the current template, the first template and the second template individually to determine three corresponding thresholds for the current template, the first template and the second template. If the three corresponding thresholds are the same, said determining the inter direction of the MVP candidate for the current block based on first information comprising the L0 matching cost and the L1 matching cost is applied; and if the three corresponding thresholds are not the same, said determining the inter direction of the MVP candidate for the current block based on first information comprising the L0 matching cost and the L1 matching cost is not applied.

In one embodiment, if the threshold Tf of the current CU and the threshold Tt of the template are mismatched, the sample-based inter direction determination method will not be applied to the current CU.

In one embodiment, if the threshold Tf of the current CU and the threshold TLt of the left template are mismatched but the threshold Tf of the current CU and the threshold TRt of the right template are matched, the sample-based inter direction determination method will be applied to the current CU which only uses the right template to calculate the template matching cost and vice versa.

In one embodiment, the thresholds of the luma samples and the chroma samples in a bi-prediction CU can be different and can be determined separately. The sample-based inter direction determination method can be applied only to luma, only to chroma, or to both luma and chroma for each CU.

In one embodiment, the sample-based inter direction determination method is applied only if the template quality is guaranteed. That is, if the difference between current template and the respective bi-prediction template, L0 template or L1 template is larger than a threshold, the sample-based inter direction determination process is skipped. Furthermore, if the sum of residuals in the current template region is larger than a threshold which means the reconstruction is not accurate enough in the current template region, the sample-based inter direction determination process is skipped.

In one embodiment, the bi-prediction template matching cost is weighted by a factor smaller than 1 to make the inter direction determination process prone to choose bi-prediction instead of L0 or L1 uni-prediction.

In one embodiment, the sample-based inter direction determination method can be applied to inter AMVP, inter merge, Affine AMVP, Affine merge, SbTMvp and all the other inter modes.

In one embodiment, the sample-based inter direction determination method can be applied with BDOF. The L0 and L1 predictors refined by BDOF are stored and the difference between the refined L0 and L1 predictors are used to judge whether changing the inter direction of each sample in the current CU. The sample-based inter direction determination method can be applied before and/or after sample-based BDOF.

In one embodiment, the sample-based inter direction determination method can be applied with MP-DMVR/DMVR/any decoder side MV derivation/refinement tool. The L0 and L1 predictors refined by MP-DMVR/DMVR/any decoder side MV derivation/refinement tool are stored and the differences between the refined L0 and L1 predictors are used to judge whether changing the inter direction of each sample in the current CU. The sample-based inter direction determination method can be applied before and/or after each pass or one pass of MP-DMVR/DMVR/any decoder side MV derivation/refinement too (i.e., there 3 passes for MP-DMVR). For example, the MV used for generating the L0/L1 template can be the MV before MP-DMVR/DMVR/any decoder side MV derivation/refinement tool or after MP-DMVR/DMVR/any decoder side MV derivation/refinement tool.

### Signalling Sample-Based Inter Direction

While the sample-based inter direction may improve the coding performance, the performance improvement may not always be achieved for all CUs. Accordingly, a method of sample-based inter direction determination by explicit indication is disclosed. According to this method, the RD cost is used to judge whether the predictor refined by the sample-based inter direction determination method is better or not at the encoder so as to reduce the bits to be signalled to the decoder for determining whether the sample-based inter direction determination method is applied to the current CU.

In one embodiment, three RD costs are calculated: one for bi-prediction predictor and the other two for the predictors that change the samples to L0 or L1 uni-prediction if the difference between L0 and L1 predictors is larger than a threshold. The predictor with minimum RD cost will be the best predictor and the corresponding inter direction will be the best inter direction. Thus, two bits are signalled to the decoder to determine the best inter direction and whether the sample-based inter direction determination method is applied to the current CU. In one example, the decision of using L0, L1, or Bi-prediction can be reordered by the corresponding TM cost. The signalled syntax is to select the best decision in the reordered list.

In one embodiment, two RD costs are calculated for bi-prediction predictor and the predictors refined by sample-based inter direction determination using template. The predictor with minimum RD cost will be the best predictor. Thus, only one bit is signalled to the decoder to determine whether the sample-based inter direction determination method is applied to the current CU.

The decision of selection of L0/L1/Bi or whether to apply the sample-based inter direction can also be signalled in the bitstream in the TB/TU/CB/CU/CTU/CTU groups/CTU row/slice/picture/sequence-level.

### Merge Candidate List Inter Direction Reordering

According to this method, the inter direction or the predictor of each merge candidate in each merge candidate list (i.e., including regular merge, GPM, MMVD, TM, BM, Affine, CIIP, etc.) can be refined by the CU-based inter direction determination method.

In one embodiment, the inter direction of each merge candidate in each candidate list is reordered according to the template matching costs of bi-prediction template, L0 template and L1 template. The final inter direction will be the inter direction with minimum template matching cost.

In one embodiment, the predictor of each merge candidate in each candidate list is refined by sample-based inter direction determination using template. The final predictor is selected from the refined merge candidate.

In one embodiment, the proposed method is set to be or not to be applied to true-bi-prediction blocks, where the reference pictures of the blocks correspond to one from the past pictures and one from the future pictures. In another embodiment, the proposed method is set to be or not to be applied to general-bi-prediction blocks, where the reference pictures of the blocks are all from the past pictures.

BCW Non-Linear Operations when Generating Final Predictors

According to this method, one non-linear operation is introduced when generating the BCW final predictor as following equation. In the original design, the final predictor is derived according to the equation (2):

$${P\_}_{bi - pred} = Clip 3 ( minValue , maxValue , ( ( 8 - w ) * P\_ 0 + w * P\_ 1 + 4 ≫ 3 ) , \qquad ( 6 )$$

where the min Value and max Value are derived according to the combination of P₀, P₁, and w.

In one embodiment, the min Value and max Value are determined by the following equations.

$$\begin{matrix}minValue = ( ( w > 4 ) ? {P}_{1} : {P}_{0} ) - thA ; \\ maxValue = ( ( w > 4 ) ? {P}_{1} : {P}_{0} ) + thA ;\end{matrix}$$

In another embodiment, the min Value and max Value are determined by the following equations.

$$\begin{matrix}minValue = ( ( w < 4 ) ? {P}_{1} : {P}_{0} ) - thA ; \\ maxValue = ( ( w < 4 ) ? {P}_{1} : {P}_{0} ) + thA .\end{matrix}$$

In one embodiment, thA is signalled in the CU level, CTU level, slice level, picture level or sequence level. In another embodiment, thA is implicitly derived according to QP and some predefined values. For example, when QP is increased, thA is also increased. In another example, when QP is increased, thA is decreased. In another example, thA is dependent on the selected reference pictures, such as the temporal distances of two reference frames, slice QP of reference pictures, and so on. In another example, thA is dependent on motion vectors. For example, if two motion vectors are close to each other, a large value is used for thA. Otherwise, a small value is used as thA.

In one embodiment, these non-linear operations are applied only when some specific weight pair is selected. For example, only when the weight pair with “8-w” larger than 4 is selected, non-linear operations are introduced to generate the final predictors. For the others, the original equation (6) is used.

In one embodiment, the proposed method is only applied to CUs with size larger than or equal to some pre-defined sizes. In another embodiment, the proposed method is only applied to CUs with size smaller than some pre-defined sizes. The size can be width only, height only, both or the product of width and height.

In one embodiment, the selection between P₀ and P₁ is decided according to neighbouring reconstructed samples. In one example, template matching can be applied to select one of P₁ and P₀.

In another example, block boundary matching is used to select one of P₁ and P₀. The difference between a neighbouring reconstructed sample and each of predictors is calculated. Then, according to these two differences, the selection of P₁ and P₀ can be determined. The selection can be made at the sample level, segment level, or CU level. If the selection is made at the sample level, the selection for each sample can be different. If the selection is made at the CU level, the selection is the same for all samples in one CU.

### BCW Asymmetric Weight Set

According to this method, the asymmetric BCW weight sets are proposed. In the original design, the design of BCW weights is symmetric. That is, if one weight pair {w0, w1} for L0 and L1 is supported in the set of BCW weights, the symmetric weight part {w1, w0} for L0 and L1 is also supported. However, in some cases, this design may introduce some redundancy. For example, if the reference frames in L0 and L1 are the same, we can swap the MVs, the corresponding reference pictures, and the selected BCW weights in L0 and L1, and get the same final predictor. In order to remove this redundancy, we propose an asymmetric weight set of BCW weights. That is, if one weight pair {w0, w1} for L0 and L1 is supported in the set of BCW weights, the symmetric weight part {w1, w0} for L0 and L1 will not be supported. That is, the sum of two weights from any two weight pairs cannot be the same as the sum of one weight pair. For example, the original of BCW weights is {−2, 3, 4, 5, 10}. The sum of two weights from the first weight pair and the last one will be −2+10=8. The sum of two weights from the second weight pair and the fourth one will be 3+5=8. So, they are symmetric weighting pairs. In the proposed method, the set of BCW weights will be something like {−1, 1, 4, 5, 10}, {−1, 2, 4, 5, 10}, {−3, 1, 4, 5, 10}, {−3, 2, 4, 5, 10}, or {−3, 1, 4, 5, 10}. The sum of two weights from any two weight pairs is not equal to 8.

### Interaction Between BCW, MVD Sign Prediction, and Adaptive Reference Picture Reordering

According to this method, the process of MVD sign prediction and adaptive reference picture are independent of BCW. That is, regardless of the selection of BCW, MVD sign prediction and adaptive reference picture can be always applied to the current CU. However, the selection of BCW is designed for the current MV pair, and it may not be good for MVD sign prediction, and adaptive reference picture reordering, since these coding tools improve the signalling by considering only one of the current MV pair. In order to improve this, we proposed the following methods.

In one embodiment, the usage of BCW and MVD sign prediction (and/or adaptive reference picture reordering) are mutually exclusive. That is, when one unequal weight pair in BCW is used, MVD sign prediction (and/or adaptive reference picture reordering) cannot be used.

In one embodiment, the usage of BCW and MVD sign prediction (and/or adaptive reference picture reordering) are mutually exclusive, only when some specific unequal weight pairs are selected. For example, when one of the selected weight pair in BCW is negative, the usage of BCW and MVD sign prediction (and/or adaptive reference picture reordering) are mutually exclusive. Otherwise, BCW and MVD sign prediction (and/or adaptive reference picture reordering) can be applied together. In another embodiment, when the difference between two weights in the selected weight pair in BCW is larger than a predefined threshold, the usage of BCW and MVD sign prediction (and/or adaptive reference picture reordering) are mutually exclusive. Otherwise, BCW and MVD sign prediction (and/or adaptive reference picture reordering) can be applied together.

In another embodiment, the CABAC context selection and/or context modelling of MVD sign prediction (and/or adaptive reference picture reordering) depends on the selection of BCW. For example, there are two sets of CABAC context for MVD sign prediction and adaptive reference picture reordering. One is used for BCW with the equal weights, and the other is used for BCW with unequal weights.

In another embodiment, the usage of BCW and MVD sign prediction (and/or adaptive reference picture reordering) can be applied together. In this embodiment, the bi-directional template matching is applied. The encoder or decoder uses the reference samples from two or more inputs (e.g. two different pictures or same picture with different blocks) to generate a bi-predicted template. A template matching cost is calculated by using the neighbouring reconstructed samples and the bi-predicted template. When generating the bi-predicted template, the inherited BCW weighting is considered. The bi-predicted template with considered BCW weighting is used for MVD sign prediction (and/or adaptive reference picture reordering) process.

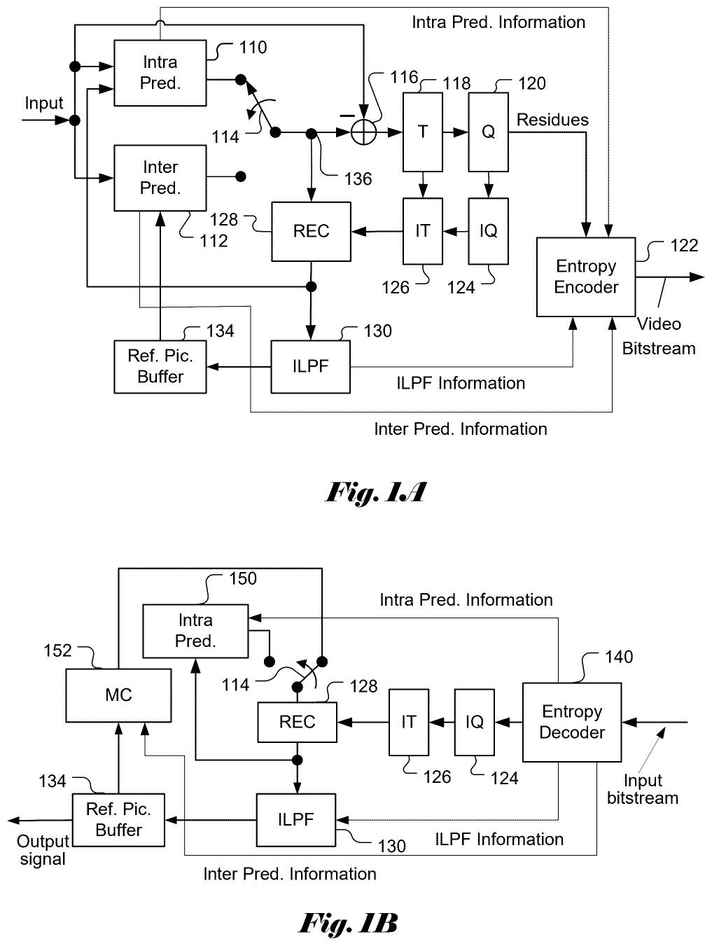

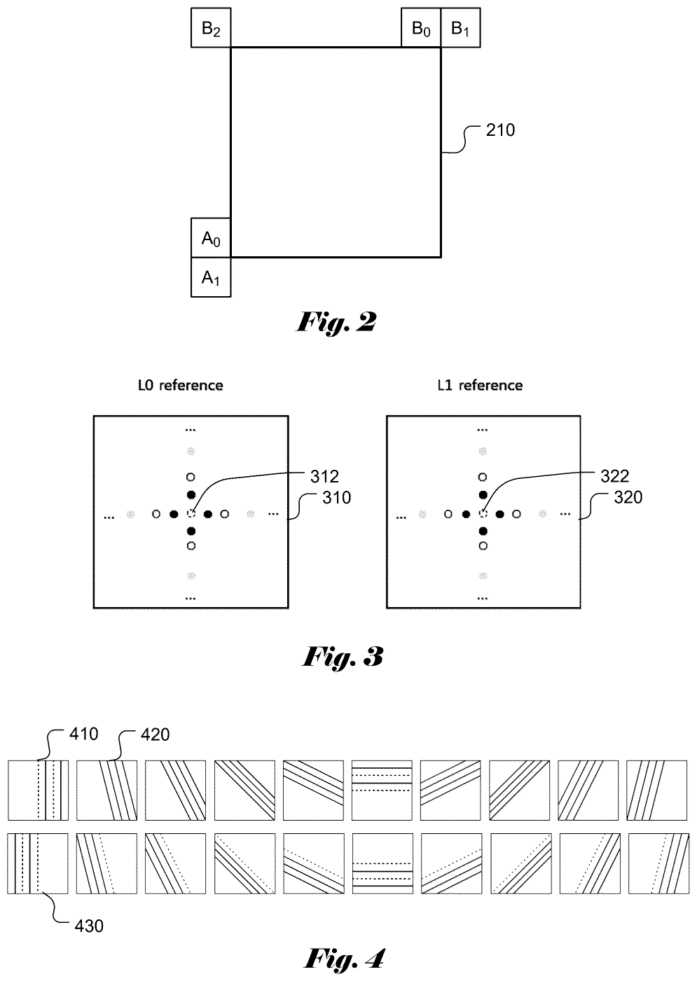

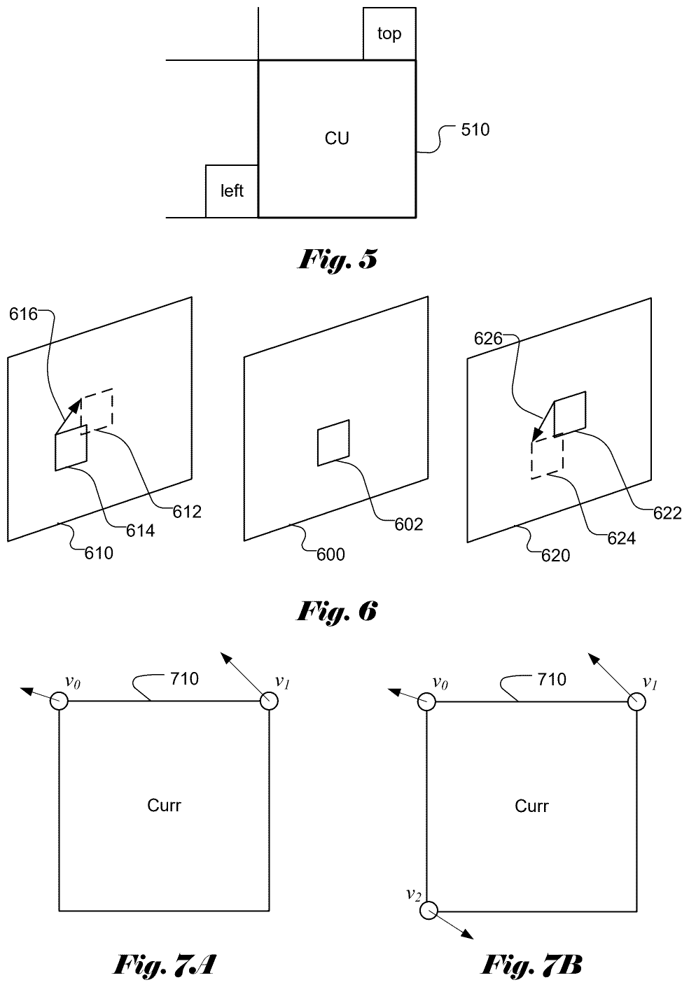

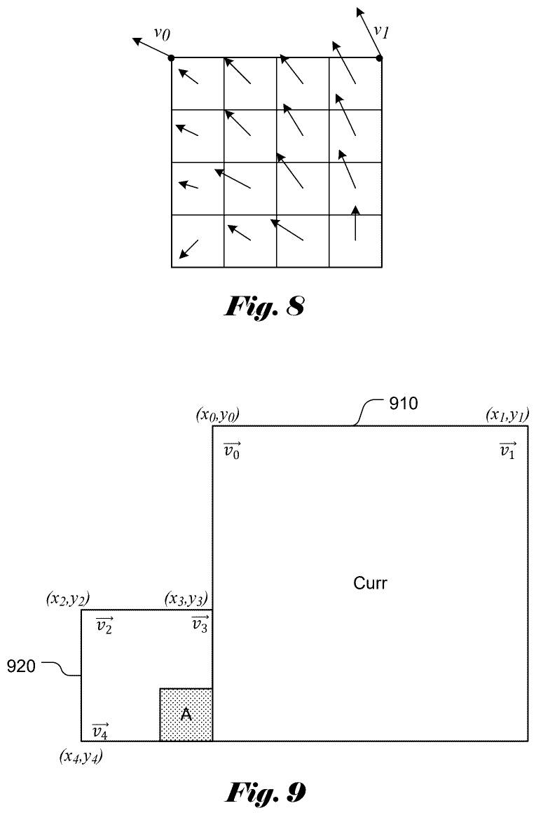

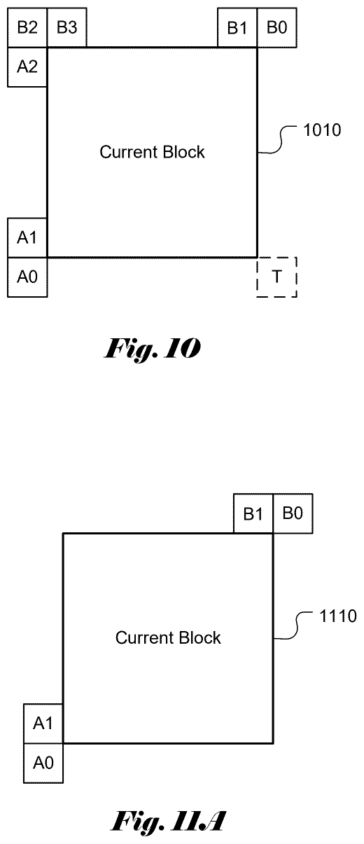

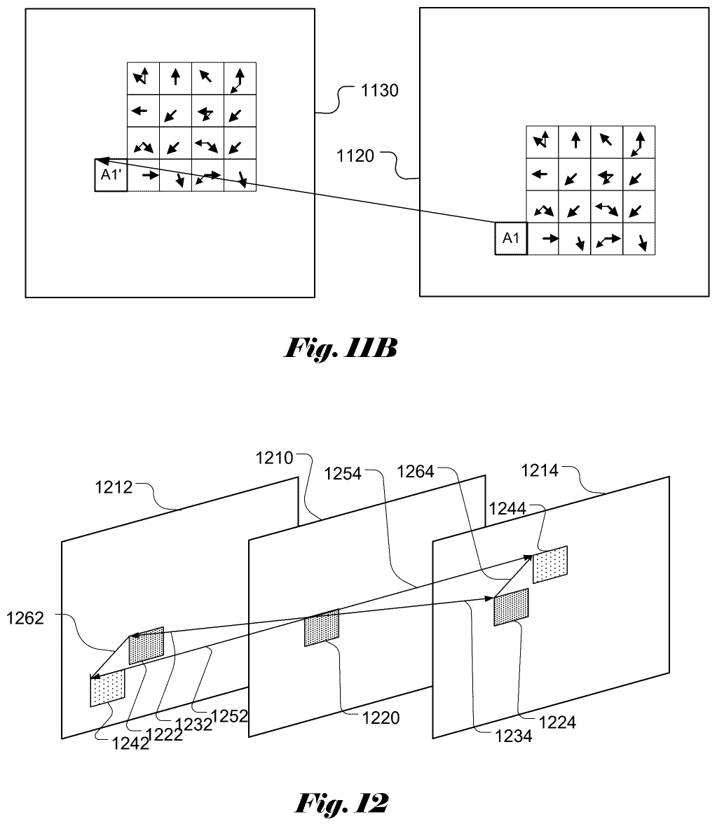

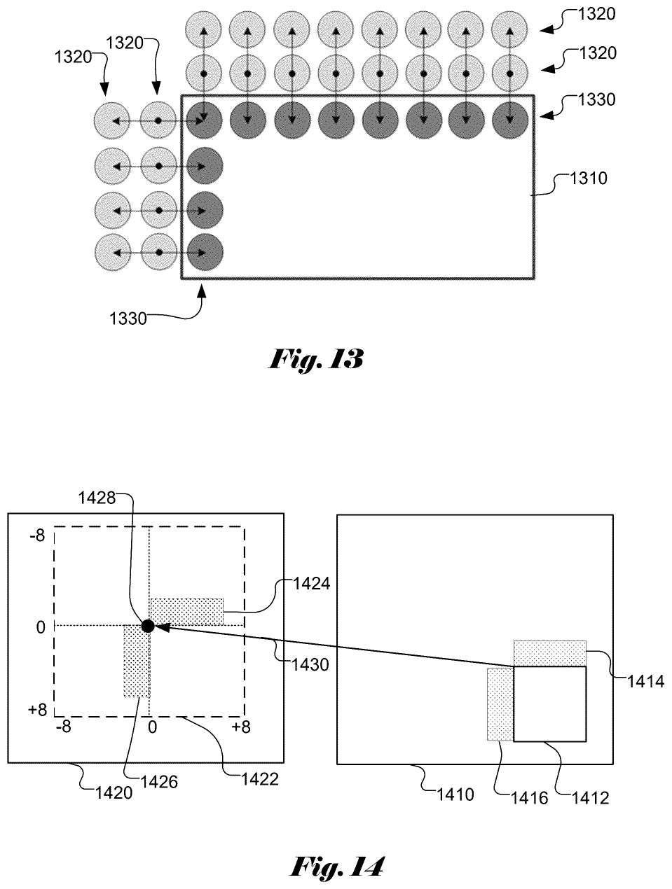

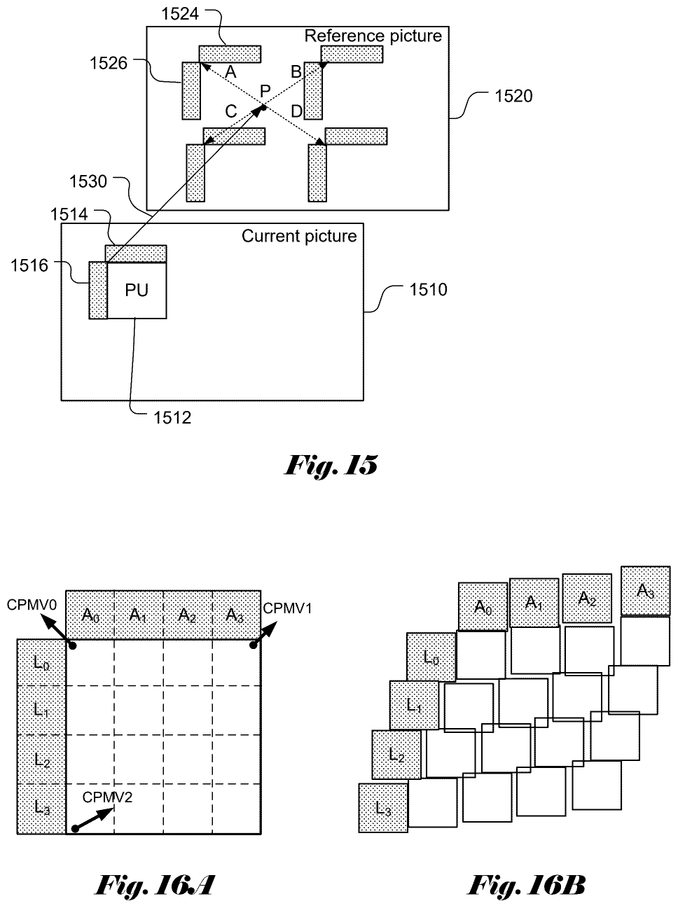

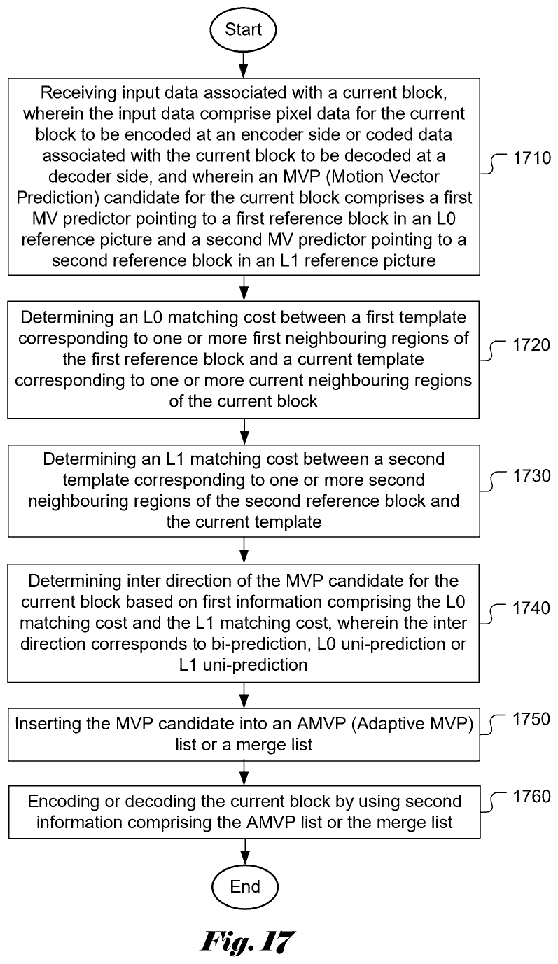

Any of the foregoing proposed inter direction determination according to template matching cost can be implemented in encoders and/or decoders. For example, any of the proposed methods can be implemented in an inter coding module (e.g. Inter Pred. 112 in FIG. 1A) of an encoder or a motion compensation module (e.g., MC 152 in FIG. 1B). Since the MVP may be involved in merge/AMVP candidate construction, the present invention or part of the present invention may also be implemented in a merge candidate derivation module of an encoder or a decoder. Alternatively, any of the proposed methods can be implemented as a circuit coupled to the inter coding module and/or entropy coding module, and/or a merge candidate derivation module at an encoder and/or the decoder.

FIG. 17 illustrates a flowchart of an exemplary video coding system that determines the inter direction for an MVP candidate according to template matching costs according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block are received in step 1710, wherein the input data comprise pixel data for the current block to be encoded at an encoder side or coded data associated with the current block to be decoded at a decoder side, and wherein an MVP (Motion Vector Prediction) candidate for the current block comprises a first MV predictor pointing to a first reference block in an L0 reference picture and a second MV predictor pointing to a second reference block in an L1 reference picture. An L0 matching cost between a first template corresponding to one or more first neighbouring regions of the first reference block and a current template corresponding to one or more current neighbouring regions of the current block is determined in step 1720. An L1 matching cost between a second template corresponding to one or more second neighbouring regions of the second reference block and the current template is determined in step 1730. Inter direction of the MVP candidate for the current block is determined based on first information comprising the L0 matching cost and the L1 matching cost in step 1740, wherein the inter direction corresponds to bi-prediction, L0 uni-prediction or L1 uni-prediction. The MVP candidate is inserted into an AMVP (Adaptive MVP) list or a merge list in step 1750. The current block is encoded or decoded by using second information comprising the MVP list or the merge list in step 1760.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprise pixel data for the current block to be encoded at an encoder side or coded data associated with the current block to be decoded at a decoder side, and wherein an MVP (Motion Vector Prediction) candidate for the current block comprises a first MV predictor pointing to a first reference block in an L0 reference picture and a second MV predictor pointing to a second reference block in an L1 reference picture;
determining an L0 matching cost between a first template corresponding to one or more first neighbouring regions of the first reference block and a current template corresponding to one or more current neighbouring regions of the current block;
determining an L1 matching cost between a second template corresponding to one or more second neighbouring regions of the second reference block and the current template;
determining inter direction of the MVP candidate for the current block based on first information comprising the L0 matching cost and the L1 matching cost, wherein the inter direction corresponds to bi-prediction, L0 uni-prediction or L1 uni-prediction;
inserting the MVP candidate into an AMVP (Adaptive MVP) list or a merge list; and
encoding or decoding the current block by using second information comprising the AMVP list or the merge list.

2. The method of claim 1, wherein a bi-prediction matching cost is calculated between a blended template and the current template, and wherein the blended template is derived by blending the first template and the second template.

3. The method of claim 2, wherein the bi-prediction matching cost, the L0 matching cost and the L1 matching cost are calculated according to a sum of absolute differences (SAD) or a sum of squared differences (SSD).

4. The method of claim 2, wherein the bi-prediction matching cost is weighted by a factor smaller than 1 for matching cost comparison among the L0 matching cost, the L1 matching cost and the bi-prediction matching cost.

5. The method of claim 2, wherein the inter direction of the MVP candidate is determined for the current block on a per sample basis, or the inter direction of the MVP candidate is determined for the current block on a per block basis.

6. The method of claim 5, wherein a target sample in the current block is a candidate to be changed from the bi-prediction to a uni-prediction if a difference between a corresponding L0 reference sample of the target sample and a corresponding L1 reference sample of the target sample is greater than a threshold.

7. The method of claim 6, wherein the target sample is changed to the L0 uni-prediction if the L0 matching cost is a smallest one among the L0 matching cost, the L1 matching cost and the bi-prediction matching cost, or changed to the L1 uni-prediction if the L1 matching cost is the smallest one among the L0 matching cost, the L1 matching cost and the bi-prediction matching cost.

8. The method of claim 6, wherein the target sample stays to use the bi-prediction if the bi-prediction matching cost is a smallest one among the L0 matching cost, the L1 matching cost and the bi-prediction matching cost.

9. The method of claim 6, wherein the threshold is fixed or determined from a set of candidate thresholds.

10. The method of claim 6, wherein the threshold is adaptively determined for the current block.

11. The method of claim 10, wherein the threshold is adaptively selected from a set of candidate thresholds based on the L0 matching cost, the L1 matching cost and the bi-prediction matching cost calculated for each of the set of candidate thresholds, and the threshold corresponds to a target candidate threshold achieving a lowest matching cost among the set of candidate thresholds.

12. The method of claim 10, wherein the threshold is adaptively selected from a set of candidate thresholds based on an incremental number associated with each of the set of candidate thresholds and the incremental number is calculated as an increase from a current total number of samples with absolute difference between L0 predictor and L1 predictor smaller than a current candidate threshold to a next total number of samples with the absolute difference between L0 predictor and L1 predictor smaller than a next candidate threshold, and the threshold corresponds to a target candidate threshold having a largest incremental number among the set of candidate thresholds.

13. The method of claim 12, wherein the incremental number associated with each of the set of candidate thresholds is calculated for the current template, the first template and the second template individually to determine three corresponding thresholds for the current template, the first template and the second template, and if the three corresponding thresholds are the same, said determining the inter direction of the MVP candidate for the current block based on first information comprising the L0 matching cost and the L1 matching cost is applied; and if the three corresponding thresholds are not the same, said determining the inter direction of the MVP candidate for the current block based on first information comprising the L0 matching cost and the L1 matching cost is not applied.

14. The method of claim 6, wherein the threshold is dependent on QP (Quantization Parameter) of the current block, block size of the current block, one or more template matching costs of the current block, numbers of samples in the current block having differences between corresponding L0 and L1 reference samples falling in respective threshold intervals, or a combination thereof.

15. (canceled)

16. (canceled)

17. The method of claim 6, wherein the MVP candidate for the current block corresponds to an inter AMVP candidate, an inter merge candidate, an Affine AMVP candidate, an Affine merge candidate, or an SbTMvp (Subblock-based Temporal Motion vector prediction) candidate.

18. The method of claim 6, wherein the current block corresponds to a luma block or a chroma block, wherein the threshold is different between the luma block and the chroma block.

19. (canceled)

20. The method of claim 6, wherein RD (Rate-Distortion) costs for the current block using per-sample-based inter direction determination and without using the per-sample-based inter direction determination are calculated to decide whether to apply the per-sample-based inter direction determination for the current block.

21. The method of claim 20, wherein three RD costs are calculated and a decision regarding whether to use the per-sample-based inter direction determination and a corresponding inter direction associated with a smallest RD cost are selected for the current block, and wherein a first RD cost corresponds to coding the current block using the bi-prediction, a second RD cost and a third RD cost correspond to coding the current block using the L0 uni-prediction and the L1 uni-prediction respectively for samples in the current block having differences between corresponding L0 and L1 reference samples greater than the threshold.

22. The method of claim 21, wherein two bits are signalled to indicate whether to use the per-sample-based inter direction determination and the corresponding inter direction.

23. The method of claim 20, wherein two RD costs are calculated and a decision regarding whether to use the per-sample-based inter direction determination is determined for the current block, and wherein a first RD cost corresponds to coding the current block using the bi-prediction and a second RD cost corresponds to coding the current block using the L0 uni-prediction or the L1 uni-prediction according to the L0 matching cost and the L1 matching cost for samples in the current block having differences between corresponding L0 and L1 reference samples greater than the threshold.

24. The method of claim 23, wherein one bit is signalled to indicate whether to use the per-sample-based inter direction determination.

25. (canceled)

26. The method of claim 25, wherein the MVP candidate corresponds to regular merge candidate, a GPM (Geometric Partitioning Mode) candidate, an MMVD (Merge Motion Vector Difference) candidate, a BM (Bilateral-Matching) candidate, or an Affine candidate, a CIIP candidate.

27. An apparatus for video coding, the apparatus comprising one or more electronics or processors arranged to:
receive input data associated with a current block, wherein the input data comprise pixel data for the current block to be encoded at an encoder side or coded data associated with the current block to be decoded at a decoder side, and wherein an MVP (Motion Vector Prediction) candidate for the current block comprises a first MV predictor pointing to a first reference block in an L0 reference picture and a second MV predictor pointing to a second reference block in an L1 reference picture;
determine an L0 matching cost between a first template corresponding to one or more first neighbouring regions of the first reference block and a current template corresponding to one or more current neighbouring regions of the current block;
determine an L1 matching cost between a second template corresponding to one or more second neighbouring regions of the second reference block and the current template;
determine inter direction of the MVP candidate for the current block based on first information comprising the L0 matching cost and the L1 matching cost, wherein the inter direction corresponds to bi-prediction, L0 uni-prediction or L1 uni-prediction;
insert the MVP candidate into an AMVP (Adaptive MVP) list or a merge list; and
encode or decode the current block by using second information comprising the AMVP list or the merge list.
